(19) United States
(12) Patent Application Publication
(10) Pub. No.: US 2018/0036990 A1
(43) Pub. Date: Feb. 8, 2018

(54) AIR PILLOW MACHINE

(71) Applicant: Intertape Polymer Corp., Sarasota, FL (US)

(72) Inventor: Mark Douglas Drysdale, Wainfleet (CA)

(21) Appl. No.: 15/668,777

(22) Filed: Aug. 4, 2017

Related U.S. Application Data
(60) Provisional application No. 62/370,803, filed on Aug. 4, 2016.

(51) Int. Cl. B31D 5/00; G01P 3/48; B65B 57/16; B65B 65/02; B65B 41/00; B65B 51/22

(52) U.S. Cl. CPC B31D 5/0073; B65B 41/00; B65B 51/22; B65B 57/16; B65B 65/02; G01P 3/48; B31D 2205/0082; G01D 5/145

(57) ABSTRACT

An air pillow machine system may include an air pillow machine including a primary base plate having mounted thereto a feeding mechanism, an inflating mechanism, and a sealing mechanism. The primary base plate of the air pillow machine may be removably slidingly received within a frame. The frame may be one of mounted at least partially within a housing and integral with the housing. A portion of each of the feeding mechanism, inflating mechanism, and sealing mechanism that engage an uninflated pillow-precursor may protrude away from the primary base plate and away from the frame.

### CROSS-REFERENCE TO RELATED APPLICATION

This application claims the benefit of U.S. provisional patent application Ser. No. 62/370,803, entitled “Air Pillow Machine,” filed on Aug. 4, 2016, the entire disclosure of which is incorporated herein by reference.

### TECHNICAL FIELD

The present invention relates to air pillow machines, in particular, air pillow machines that are modular.

### BACKGROUND

Many techniques have been used to pack items for shipping and to absorb impacts during shipment to protect shipped items, such as foam peanuts, molded foam components, formed paper, crumpled paper, inflated air pillows and molded pulp packaging components. Inflated air pillows have become an accepted, cost effective packaging product because rolls of uninflated preformed plastic film material can be shipped to customers for onsite filling using an air pillow machine, which allows the customer direct control over the filling and packaging of the air pillows into the box with the product to be shipped.

There is always a need for improvement in air pillow machines, such as a smaller machine that is faster and easier to repair, which equates to reductions in down time. Machines fulfilling these needs are disclosed herein.

### SUMMARY

According to an embodiment, an air pillow machine system may include an air pillow machine including a primary base plate having mounted thereto a feeding mechanism, an inflating mechanism, and a sealing mechanism. A frame may have the primary base plate of the air pillow machine removably slidingly received therein. The air pillow machine system may also include a housing. The frame may be one of mounted at least partially within the housing and integral with the housing. A portion of each of the feeding mechanism, inflating mechanism, and sealing mechanism that engage an uninflated pillow-precursor protrude away from the primary base plate and away from the frame.

One or more of the following features may be included. The air pillow machine may be secured within the frame by a releaseably attachable top plate. One or more of a motor and one or more sensors may be electrically connected to one of a plug and a plug receptacle mounted to the primary base plate. One of the one or more sensors may include a traction wheel rotated by the uninflated pillow-precursor fed through the air pillow machine and a device to sense the speed of the traction wheel. The device to sense the speed of the traction wheel may send a signal indicative of the speed of the traction wheel to a controller configured to change the power to the motor based upon, at least in part, the signal. The traction wheel may include a plurality of spaced apart holes in at least one axial faces of the traction wheel. The device to sense the speed of the traction wheel may include a sensor configured to sense one or more of the passage of the plurality of spaced apart holes and surfaces in between the plurality of holes as the traction wheel rotates. The sensor may be a Hall effect sensor.

The sealing mechanism may include a heating element electrically connected to a controller. The controller may be configured to monitor a resistance of the heating element and to control a voltage applied to the heating element to maintain the heating element at a constant temperature. The inflating mechanism may include a fan having a surge line. The fan may be a vane style blower. The fan may be positioned to cool electronics of the air pillow machine as ambient air is drawn into the fan. The sealing mechanism may include an insulator block holding a heating element relative to a first belt of the feeding mechanism to seal the pillow-precursor subsequent to inflation. The sealing mechanism may also include a first electrical plug connected to a first end of the heating element and a second electrical plug connected to a second end of the heating element. The first and second electrical plugs may protrude from the insulator block and may be configured to be plugged into receptacles coupled to the primary base plate. In an embodiment, the frame may have maximum dimensions of 12 inches by 10 inches by 6 inches.

### BRIEF DESCRIPTION OF THE DRAWINGS

FIG. 1 is an exploded, perspective view of one example embodiment of an air pillow machine system.

FIG. 2 is an assembled, perspective view of the air pillow machine system of FIG. 1.

FIG. 3 is a bottom, plan view of the air pillow machine system of FIG. 1 without a bottom plate of the frame.

FIG. 4 is a perspective, bottom view of the air pillow machine system of FIG. 1 with one support of the traction wheel removed.

FIG. 5 is a top, plan view of one example embodiment of an air pillow machine.

FIG. 6 is a top, perspective view of one example embodiment of an insulated heating block of the air pillow machine.

FIG. 7 is a side, perspective view of one example embodiment of the insulated heating block of FIG. 6.

FIG. 8 is a photograph of an example embodiment of an air pillow machine assembly with uninflated air pillow precursors being fed therethrough.

FIGS. 9-11 are alternate views of example touch screen display of an illustrative embodiment of an air pillow machine.

### DETAILED DESCRIPTION

The following detailed description of illustrative example embodiments will illustrate the general principles consistent with the disclosure, examples of which are additionally illustrated in the accompanying drawings. In the drawings, like reference numbers indicate identical or functionally similar elements.

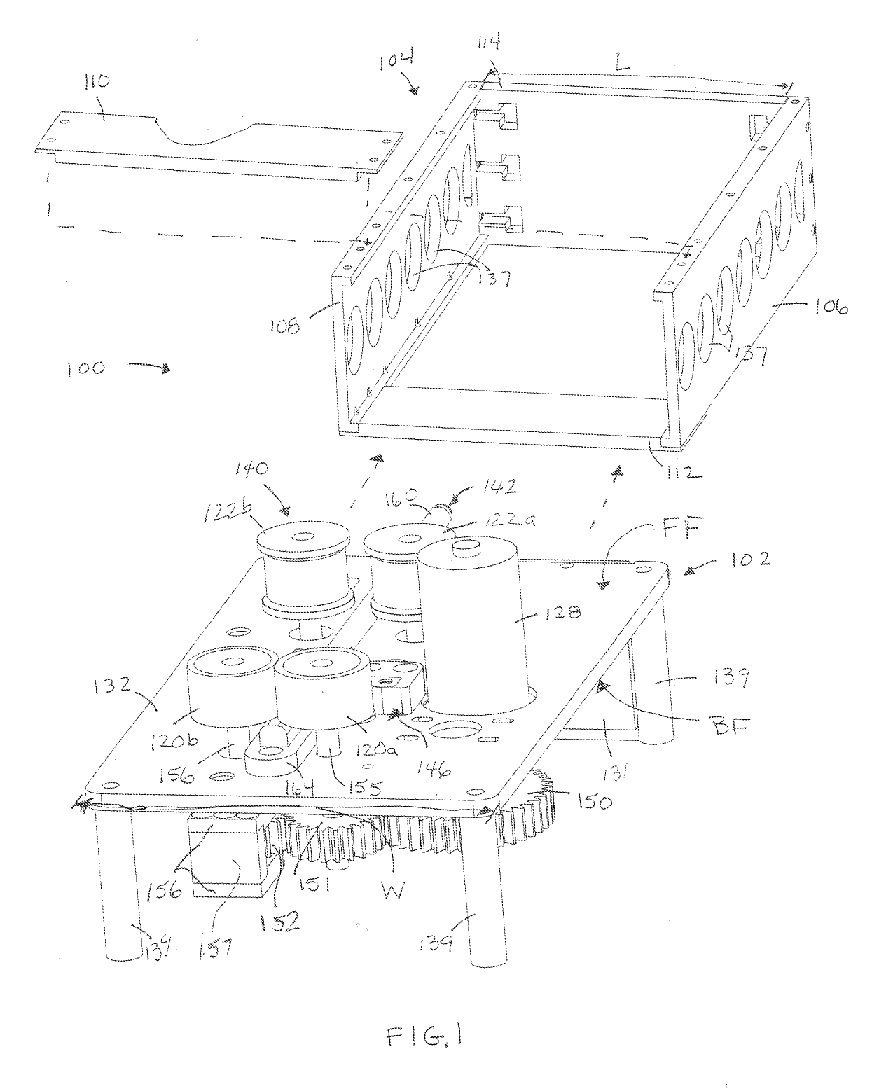

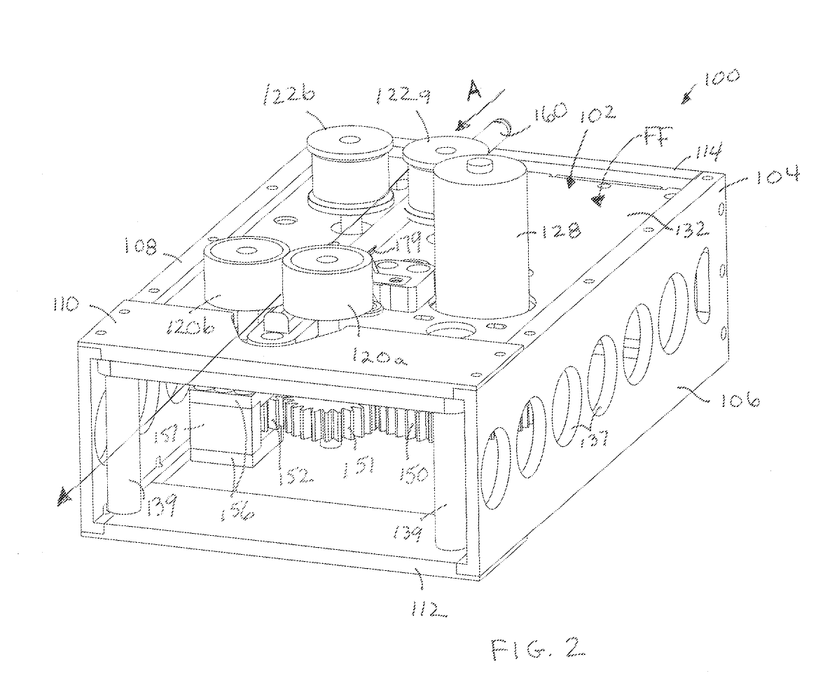

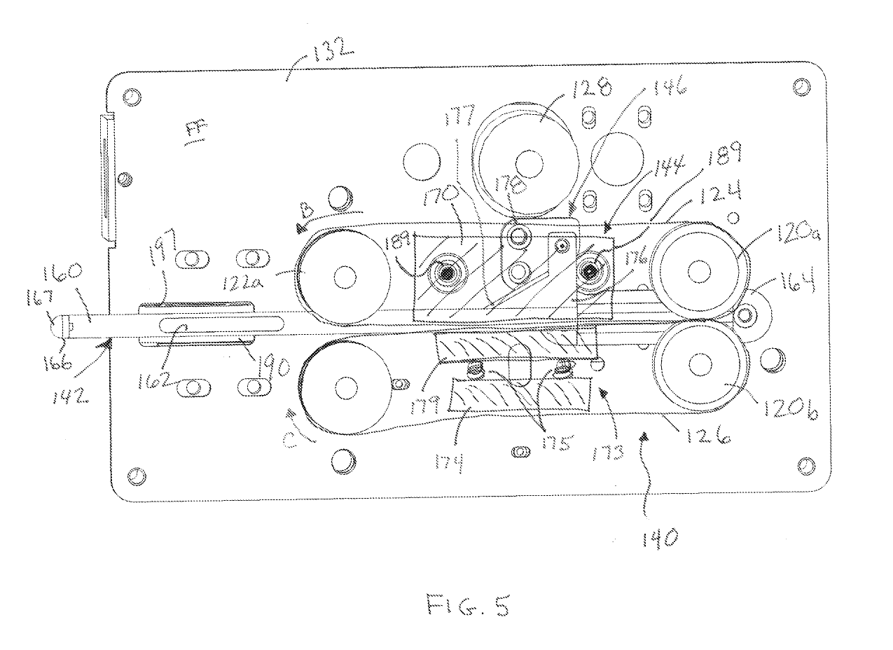

The present disclosure generally describes systems and methods for converting uninflated film pillow-precursors into inflated pillows that may be used as cushioning for packaging and shipping goods. FIGS. 1 and 2 show an illustrative embodiment of an air pillow machine system 100, first, in an unassembled state and, then, in an assembled state for inflating and sealing the uninflated film pillow-precursors into inflated pillows. According to one aspect, the depicted illustrative embodiment may demonstrate modularity of the air pillow machine system 100 including a capability for sliding the air pillow machine 102, in its entirety (and/or one or more subcomponents thereof), into the frame 104. The air pillow machine 102 may include a primary base plate 132 having mounted thereto a feeding mechanism 140, an inflating mechanism 142, a sealing mechanism 144, and a cutting mechanism 146, which may be capable of moving together with the primary base plate 132 into the frame 104. In some example embodiments, the air pillow machine 102 may measure at most about twelve inches by ten inches by six inches, with respect to the portion of the machine slidingly received in the frame 104. In some further example embodiments, the air pillow machine 102 may measure at most about ten inches by eight inches by four inches. As illustrated in the assembled state of FIG. 2, the rollers 120, 122, belts 124, 126 (FIG. 5) disposed about respective sets of rollers 120, 122, the cutting mechanism 146, the air nozzle 160, and motor 128 may protrude outwardly away from the front face FF of the primary base plate 132 of the machine 102, i.e., away from the portion of the machine 102 enclosed within the frame 104, and are not included in the foregoing illustrative example dimensions. Hence, a portion of each of the feeding mechanism 140, inflating mechanism 142, and sealing mechanism 144 that may engage an uninflated film pillow-precursor may protrude away from the primary base plate and away from the frame 104.

As shown, the base plate 132 may include a plurality of preselectively positioned bore holes therethrough to receive shafts for the rollers, 120, 122, the motor 128 and/or at least a portion of the wiring for the motor, an air passageway for fluid communication between a fan 138 and an inflation nozzle 160, openings for other wiring for sensors and/or power to the heating element 172, and fastener openings for mounting various components thereto. The fasteners may include any suitable fasteners and/or combinations of fasteners, such as screws, bolts, rivets, or the like. The edges of the base plate 132 that contact the opposing side rails 106, 108 of frame 104 may include a friction reducing coating applied thereto, e.g., which may make it easier to slide the air pillow machine 102 into the frame 104. One example coating is a polytetrafluoroethylene (PTFE) impregnated hard anodize coating. Consistent with the illustrative example embodiment, the base plate 132 may have a plurality of legs 139 extending from the back face BF, for example, generally from the corners of the plate, to provide additional rigidity to the base plate to hold the working components such as the gears 150-152 and the fan 138 a spaced apart distance (clearance) from the frame 104 and/or a housing enclosing the frame 104 and the portion of the air pillow machine enclosed therein. In some embodiments, this clearance may also reduce the risk that the working parts may be damaged by hitting the frame 104 as the air pillow machine 102 is slid into the frame. Further, in some embodiments, the clearance may reduce the risk of overheating during operation.

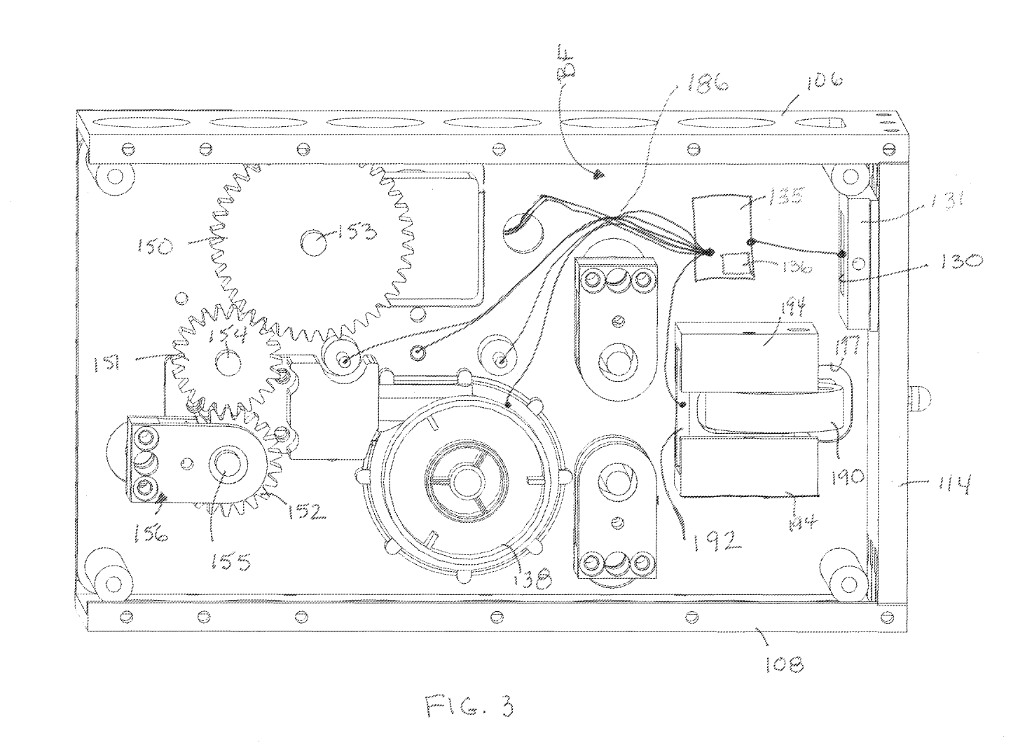

Consistent with the illustrated example embodiment, in some implementations the air pillow machine 102 may provide a unique modularity in that the entirety of the working parts slides into and out of the frame 104 and, therefore, is replaceable by a new unit in the event of a repair or failure of any single component thereof. The air pillow machine 102 may include one or more male or female electrical connectors (e.g., a plug 130) fixedly connected to the primary base plate 132 by a plug plate 131, which makes it easier to unplug and reconnect the plug 130. The plug 130 may provide an electrical connection for connecting and disconnecting all, and/or at least a portion, of the onboard electronics 135 (FIG. 3) and/or at all, or at least a portion, of the wiring for electrical components (e.g., if no computer processing unit is included as part of air pillow machine 102) to off-board electronics. Consistent with such an embodiment, the frame 104 may be simply opened by removing the releaseably attachable top plate 110, unplugging (e.g., via plug 130) the onboard electronic 135 of the air pillow machine 102 from the off-board electronics, and sliding the air pillow machine 102 out of the frame 104. Then, a new air pillow machine may slide into the frame 104. The plug 130 of the new air pillow machine may be reconnected, and the top plate 110 is fastened back in place. This construction may provide the customer the advantage of having a replacement air pillow machine on site waiting to be installed in the event of some malfunction. Down time may, therefore, be avoided and the unit in need of repair can be sent to the manufacturer and a new unit ordered to be on site.

Referring to FIG. 1, consistent with the illustrated embodiment, the frame 104 may include opposing, spaced apart side rails 106, 108, which are spaced apart by an end panel 114, seated therebetween, that has a length (L) slightly longer than the width (W) of the primary base plate 132 of the air pillow machine 102. Also, the frame 104 may include generally, opposing top and bottom plates 110, 112 seated on exterior surfaces of the opposing side rails 106, 108 with an orientation that is perpendicular to the end panel 114. The end opposite the end panel 114 may include an open face defined by the opposing side rails 106, 108 and the top and bottom plates 110, 112. The plug 130 of the air pillow machine 102 may be at either end of the frame 104 when the air pillow machine 102 is inserted therein. In an embodiment in which the plug 130 is adjacent the end panel 114, then the end panel 114 may define a cooperating opening (not shown) through which a cord with a mating plug (not shown) may be received.

At least the first side rail 106 and the second side rail 108 of the frame 104 may include a plurality of holes 137 therethrough as air vents to allow heat to dissipate and/or to allow ambient air to be drawn to the fan 138. In an embodiment, the plurality of holes 137 may be positioned relative to the onboard electronics 135 to draw external ambient air thereacross to cool the electronics on its way to the fan 138. The fan 138 may include part of the inflating mechanism 142, and in some embodiments may include a surge line. In one embodiment, the fan 138 may be a vane style blower.

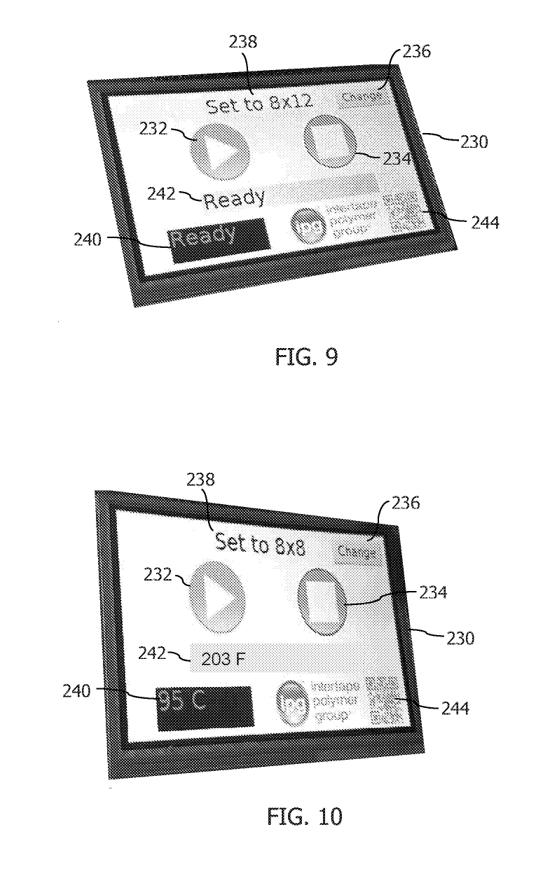

In some embodiments, frame 104 may be mounted within and/or may be an integral part of a housing or shell (not shown) forming a decorative or more visually appealing exterior that may also provide some degree of protection for an end user (e.g., the user's fingers) from the moving parts of the air pillow machine (such as the gears). In some embodiments, the housing or shell may be insulated in part to reduce noise. In some such embodiments, the insulation may be positioned such that heat will not build up within the frame 104 to a degree that may compromise the operation and/or useful life of the air pillow machine. FIG. 8 is a photograph of one embodiment of an air pillow machine assembly 200 comprising the air pillow machine system 100 of FIGS. 1-5. In the depicted example embodiment, the uninflated film pillow-precursors 206 is provided as a roll 202 of film material wound on core 204. The film material may be pulled through the air pillow machine assembly 200 in the path or machine direction shown by arrow “A” as explained in more detail below with reference to FIGS. 1-5. The housing 210 may include a display 216, an on-off controller 218, and other controllers 219 for other variables of the assembly 200, for example, speed of the motor, sealing temperature, plastic jams, sealing wire break, etc.

As described above, in some embodiments, the air pillow machine 102 may be slidingly and releasably, engaged with the frame 104 in a modular fashion (e.g., with the air pillow machine 102 being configured for ready removal and replacement within the frame 104). Further, in some of the described embodiments, the frame 104 may be disposed within, and/or may be an integral feature of, a housing. Consistent with one or more additional illustrative embodiments, the modularity of the air pillow machine and the frame may be leveraged to provide various unique applications an advantages. In one such embodiment, the air pillow machine may be mounted, or otherwise disposed, at the end of an articulating arm. Consistent with such an embodiment, the air pillow machine and articulating arm may be utilized as a fill in place unit. The articulating arm may be utilized to position the discharge of completed air pillows (e.g., inflated and sealed air pillows) from the air pillow machine to be over, beside, behind, or any combination thereof, a container to be filled with air pillows (e.g., to pre-fill the container with air pillows prior to placement of an article being packed and/or to fill around an article already packed in the container).

In another embodiment, the air pillow machine may be slidingly, and releasably, mounted in a frame above an overhead bin. In such a configuration, the completed air pillows discharged from the air pillow machine may be collected within the overhead bin, e.g. for subsequent distribution to one or more pack stations. In some implementations, multiple air pillow machine and frame combinations may be deployed to fill the same overhead bin to ensure a sufficient supply of air pillows to handle any demand (e.g., as may be associated with large consumption users). Consistent with the foregoing implementation, a single overhead bin of air pillows may provide a single source of distribution for supplying multiple packing stations. Accordingly, it may be possible to free up space at individual pack stations/tables (e.g., by not requiring a separate air pillow machine system at each packing station).

In another similar implementation, one or more air pillow machines may be operated, e.g. at a centralized location, and the produced air pillows may be conveyed, blown, or otherwise transported (using any combinations transport methodologies) from the centralized location to a plurality of individual packing stations (e.g., where the air pillows may be used for packing articles to be shipped). Such an arrangement may free up space at the packing stations/tables (e.g., by not requiring a separate air pillow machine system at each packing station). Additionally, such an arrangement may allow the air pillow making process to be carried out in one area by one or more operators who may be in charge of making and/or distributing air pillows.

Consistent with yet a further embodiment, the air pillow machine may be used in connection with a mobile air pillow distribution system. In one such embodiment, a complete air pillow machine system and/or the air pillow machine (alone and/or in combination with a frame) may be configured as a mobile system that may, in some implementations, be battery operated (e.g., via one or more rechargeable batteries). In some implementations the mobile air pillow system may be provided with the ability to carry extra consumables. Further, in some embodiments, the mobile air pillow machine may include a communication system (e.g., via any suitable wired or wireless communication system) that may allow individual pack stations to request replenishment of air pillows (e.g., based on the remaining quantity of air pillows at the pack station). Upon receiving the request for replenishment of air pillows from a pack station, the mobile air pillow distribution system may be transported to the requesting pack stations and a sufficient quantity of air pillows may be produced at the pack station to replenish the pack station supply. Accordingly, the single mobile air pillow machine (alone and/or with an operator of the mobile air pillow machine) may supply multiple pack stations as demand requires. Such an implementation may clean up individual pack stations, e.g., by not requiring the various pack stations to each have a dedicated air pillow machine. In some implementations, a queue system may be utilized and managed to dispatch the mobile air pillow machine to a packing stations based upon, for example, the order in which requests for air pillows are received, an urgency level of the request, a hierarchical arrangement, or other suitable queueing system.

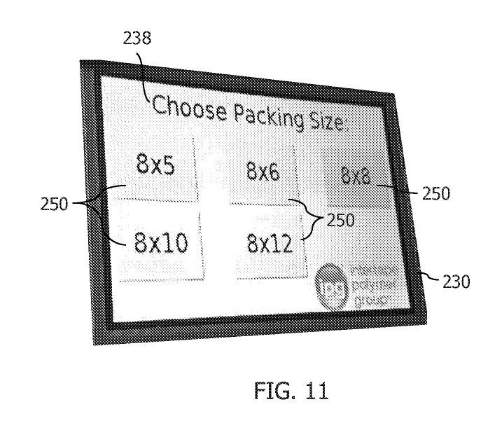

Referring now to FIGS. 9-11, in one illustrative example embodiment, the display 216 may be a touch screen user interface 230 that may enable the user to start and stop the air pillow machine 102 (buttons 232, 234), monitor the temperature of the heating element (display fields 240, 242), change the size configuration of the air pillows to be made (“Change” button 236), receive messages, and/or access the manufacture's website using a 2D bar code 244. It will be appreciated that additional and/or alternative information and/or operations may be provided via the display 216. The area of the screen for the start button 232 may be indicated by any image desirable. Here, it is a green circle with a white triangle in the center thereof. The area of the screen for the stop button 234 may be indicated by any image desirable. Here, it is a red circle with a white square in the center thereof. The area of the screen for the change air pillow size 236 may be indicated by any image desirable. Here, it is a rectangular box housing the word “Change” in the upper right corner of the screen.

In some embodiments, the screen 230 may include one, or a plurality of, display fields 238, 240, 242. The first display field 238, positioned at the top, center of the screen, may function as a screen title displaying useful information to the user. For instance, in FIG. 9, the first display field 238 may notify the user of the current air pillow size selected by reference to the dimensions thereof, “8×12.” Then, after the change button 236 is pressed, the first display field 238 may notify the user to “Choose Packing Size” as seen in FIG. 11. On the “Choose Packing Size” screen a plurality of areas of the screen may form buttons 250, each identifying a different option for the size (dimensions) of an air pillow, e.g., “8×5,” “8×6,” “8×8,” “8×10,” and “8×12.” Once a size button is pressed, the user may return to a screen similar to the display shown in FIG. 9, with the selected dimensions displayed in the first display field 238

With reference to FIG. 10, the second display field 240 may be for the temperature in Celsius of the heating element 172. The third display field 242 may be for the temperature in Fahrenheit of the heating element 172. When in between modes, these display fields 240, 242 may display the word “Ready” in each thereof; however, there is no requirement that these fields display the same message.

It will be appreciated that touch screen user interface may provide various additional and/or alternative displays, menus and/or modes of operation than those described above. Accordingly, such description should be understood as illustrative and not limiting on the scope of the present disclosure.

Referring again to FIG. 8, in an illustrative example embodiment of the air pillow machine assembly 200, the frame 104 may be integral with the lower portion of the housing 210. The housing 210 may include a support arm 212, which may be adjustable to provide clearance for different sized uninflated air pillow precursors 206. A dispensing platform 214 may also be included that rotates to dispense the uninflated air pillow precursors 206 as a continuous strip of film material into the air pillow machine assembly 200. Inflated air pillows 220 may then be dispensed from the assembly 200 and can be directed into a cardboard box 222 or other packaging containers or collection arrangement.

To convert the uninflated film pillow-precursors 206 into inflated air pillows 220, an opening in the film material may be inserted around the inflation nozzle 160. The inflation nozzle 160 may insert gas into the uninflated film pillow-precursors 206, inflating the film material into inflated air pillows 220. As best shown in FIG. 5, the inflation nozzle 160 may include a side inflation opening 162, e.g., a hole defined by the inflation nozzle 160 (FIG. 5). Secondly, the inflation nozzle 160 may act as a guide for the film material, and may typically be an elongate, generally straight hollow rod coupled to the base plate 132 by a tube header 164 that fluidly connects the inflation nozzle 160 to an output of the fan 138. A free end 166 of the inflation nozzle 160, which may include a generally rounded or conical tip 167, may extend forward or upstream of the side inflation opening 162 to be received in an inflation channel 221 formed between layers of the film material. The inflation channel 221 may initially be closed to trap the inflation nozzle 160 radially therein, until the film material around the inflation nozzle 160 is cut by the cutting mechanism 146.

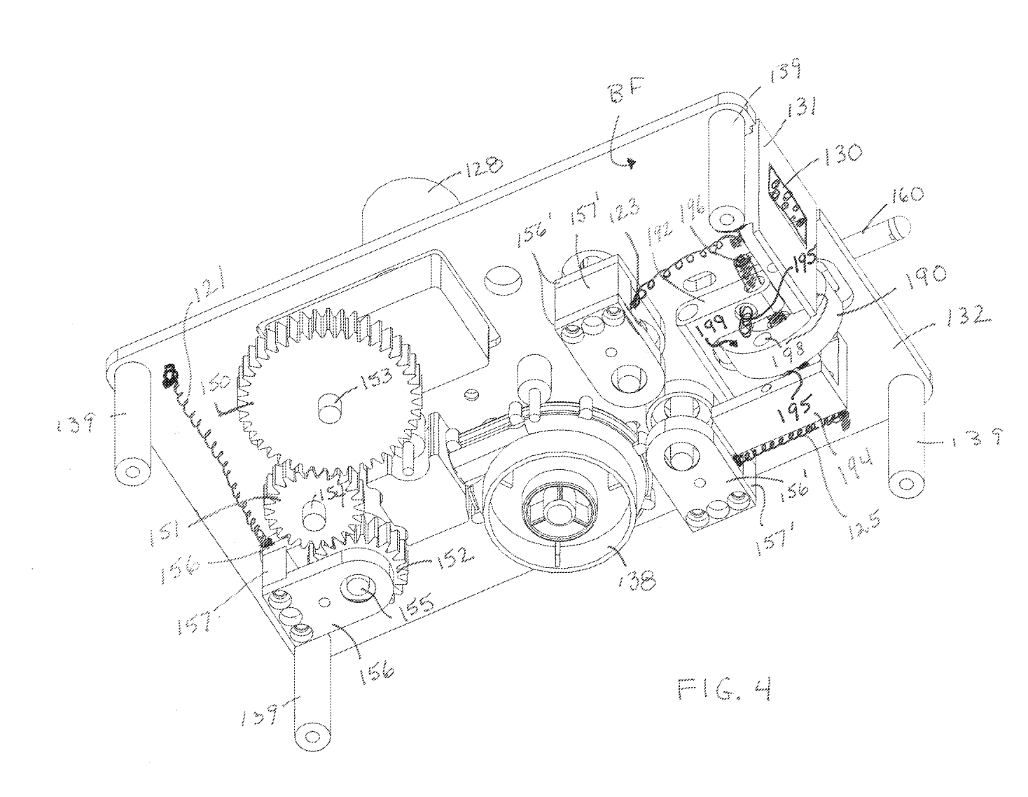

With reference to FIGS. 1-5, in the illustrated embodiment the film material may be pulled through the air pillow machine 102 in the machine direction shown by arrow “A” (labeled in FIG. 2) by the feeding mechanism 140 that may include a motor 128 geared to a set of feed rollers 120 by primary gear 150 and secondary intermeshing gears 151, 152. The primary gear 150 may be mounted to shaft 153 driven by the motor 128. The first secondary intermeshing gear 151 may be mounted to shaft 154 upon which the first of the feed rollers 120a may be seated for rotation therewith. The second secondary intermeshing gear 152 may be mounted to shaft 155 upon which the second of the feed rollers 120b may be seated for rotation therewith. The first secondary gear 151 may be mated intermeshingly to the primary gear 151 and may be mated intermeshingly to the second secondary gear 152 to transfer rotation from the primary gear 151 to the second secondary gear 152. The second of the feed rollers 120b may include a tension bearing support 156 having a bearing spacing bar 157 with the second secondary gear 152 seated between the tension bearing supports 156. As shown in FIG. 4, a first spring 121 may be attached to at least one of the tension bearing supports 156 of the feed rollers 120b to bias the gears into intermeshing relationship and to bias the feed rollers 120b toward the feed rollers 120a to form a nip between the first and second endless belts 124, 126 for pulling the film material though the air pillow machine 102.

The first endless belt 124 may be entrained about the first feed roller 120a and a first guide roller 122a aligned horizontally relative to one another and parallel to the machine direction A. The first guide roller 122a may be positioned forward or upstream relative to the first feed roller 120a. The second endless belt 126 may be entrained about the second feed roller 120b and a second guide roller 122b aligned horizontally relative to one another and parallel to the machine direction. Hereto, the second guide roller 122b may be positioned forward or upstream relative to the second feed roller 120b. Each guide roller 122 may be biased linearly to maintain or hold the first endless belt 124 and the second endless belt 126 in tension. As shown in FIG. 4, the first guide roller 122a may be operatively coupled to a second spring 123 and the second guide roller 122b may be operative coupled to a third spring 125, both of which may act to bias the guide rollers away from the gears, 150, 151, 152 to tension the belts 124, 126, respectively. Both of the guide rollers 122 may be mounted to the primary base plate by tension bearing supports 156′ separated by a spacer bar 157′.

The pair of guide rollers 122 guide the film material toward the sealing mechanism 144 and the cutting mechanism 146, but the film material may be pulled in the machine direction by the set of feed rollers 120. The set of guide rollers 122 may be nylon rollers, while the set of feed rollers 120 may typically have an exterior surface comprising a silicon material. The core of each of the feed rollers 120 may be any lightweight material of suitable durability, such as aluminum. In some embodiments, the first endless belt 124 include Teflon, since this belt is in contact with a heating element of the sealing mechanism 144. The second endless belt 126 is not required to include Teflon, but can, and in one embodiment is a silicon belt.

In an example embodiment, when a new roll of uninflated film pillow-precursor is fed into the air pillow machine 102, a first uninflated pillow-precursor may be inserted by hand around the inflation nozzle 160 and may be fed between first and second endless belts 124, 126. The first endless belt 124 may be driven in the direction shown by the arrow “B,” and the second endless belt 126 may be driven in the direction shown by arrow “C,” (labeled in FIG. 5) such that the uninflated film pillow-precursor may be driven in the machine direction “A” between the first and second belts 124, 126, which may be positioned relative to one another by the set of feed roller 120 and set of guide rollers 122 to cooperatively pull the film material through the air pillow machine 102.

As the film material is advanced through the air pillow machine 102, a fluid or inflation gas may be inserted to inflate the air pillows. Subsequent to inflation and generally commensurate with sealing of the inflated air pillow, the inflation channel 221 may be cut by the cutting mechanism 146 to increase the ease of dispensing the inflated air pillows from the air pillow machine 102. The cutting mechanism 146 may include a blade 176 releaseably attachable to a blade holder 178. The blade holder 178 may be releaseably attachable to the primary base plate 132 and may hold the cutting edge 177 of the blade 176 in a plane parallel to the upper surface of the primary base plate 132 and generally centrally positioned along a side of the air nozzle 160. The air nozzle 160 may define a shallow recess 179 (FIG. 2) in which a portion of the blade 176 may be seated to assist in holding the blade steady during operation. The cutting edge 177 may be coated with titanium nitride and/or Teflon to increase the cutting ability and wear resistance thereof. Various cutting mechanisms can be used and are not limited to the blade member and cutting edge, such as other forms of knives, sharp edges, rotating abrasive devices, etc.

Referring to FIG. 5, the blade holder 178 may be positioned underneath a portion of the sealing mechanism 144, such as the insulated block 170 that holds the heating element 172 adjacent to the first endless belt 124. In another embodiment, the blade holder 178 may be positioned underneath the support block 173. The heating element 172 may form a longitudinal seal that may be continuous along the film material by sealing together the layers of the film material that define each inflated air pillow. As mentioned above, the longitudinal seal may be formed by heating the layers of the film material with the heating element 172 through the first endless belt 124 to melt the layers together. The inflated, sealed air pillows may be advanced between the set of feed rollers 120, and then exit the first and second endless belts 124, 126 and, hence, the air pillow machine 102.

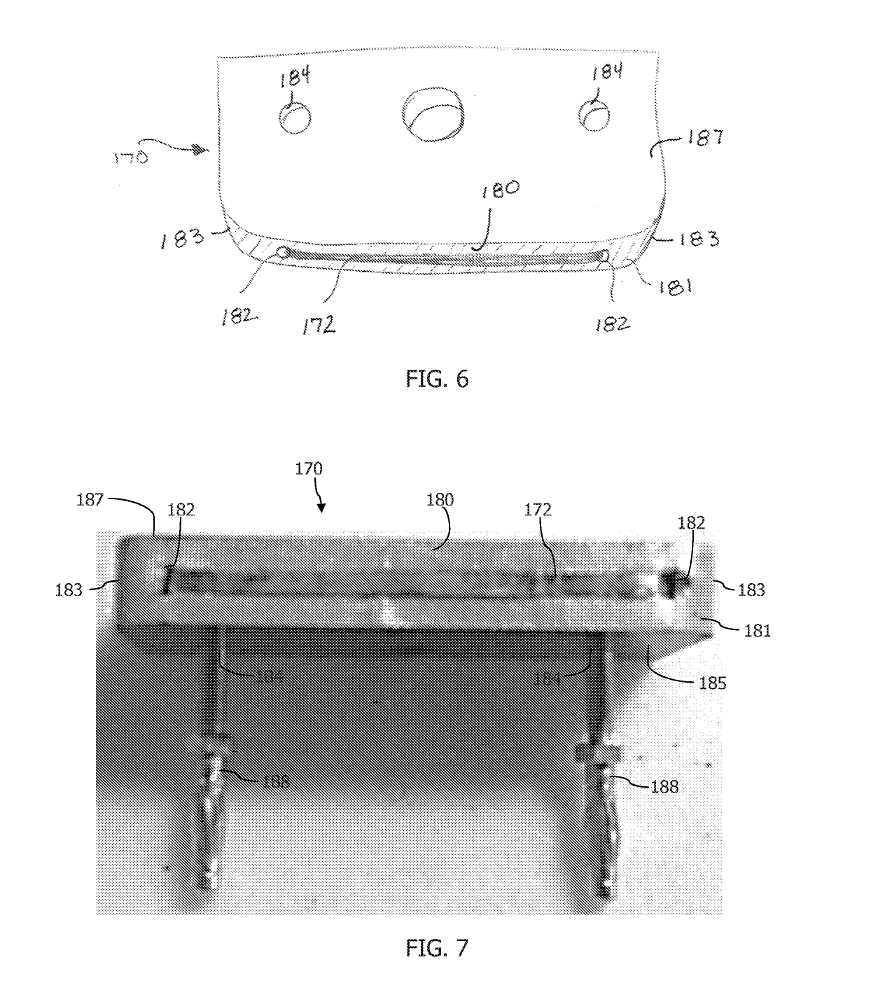

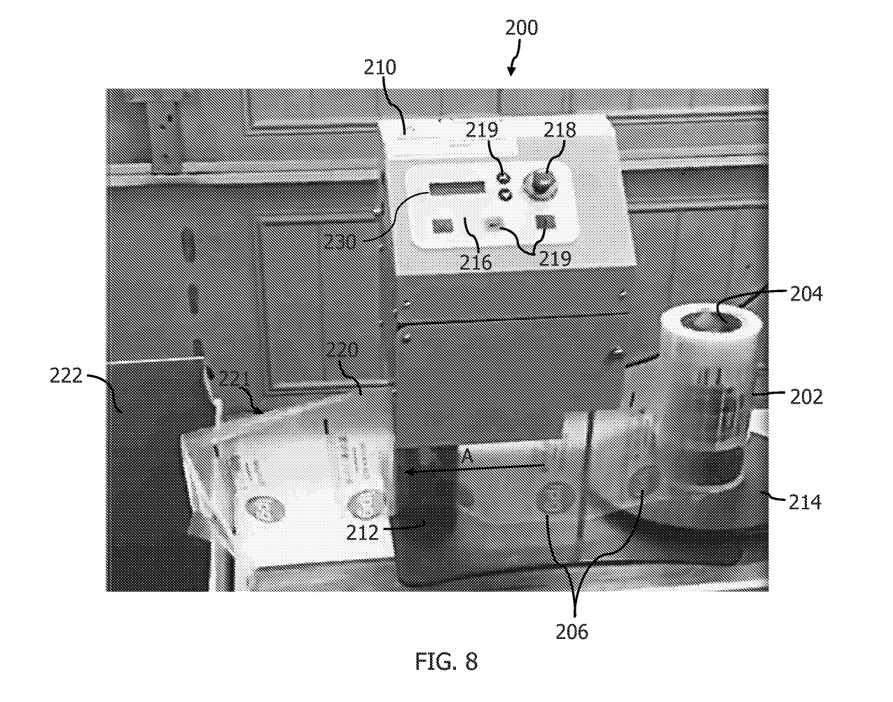

Turning to FIGS. 6-7, the insulated block 170 may hold the heating element 172 along a first side face 180 of the insulated block 170 that may be positioned against the inside surface of endless belt 124. The first side face 180 may be covered by Teflon tape 181 to protect the block from the high temperature of the heating element 172. In the first side face 180, the insulated block 170 may include first bore holes 182, one each positioned proximate one of the opposing ends 183 of the first side face 180. Each of the first bore holes 182 may extend into the insulated block 170 at least to a depth that intersects transverse second bore holes 184 extending from the back face 185 into the insulated block to a depth at least through the bore holes 182, but optionally may extend through to the front face 187 of the insulated block.

The heating element 172 may extend between the first bore holes 182, lying against the first side face 180, and into each of the first bore holes 182. Inside each of the first bore holes 182, an end (not shown) of the heating element 172 may be attached to an electrically conductive spring (not shown) that may be connected to an electrical plug protruding from one of the second bore holes 184, or directly connected to an electrical plug protruding from one of the second bore holes 184. The electrical plugs 188 are seen in FIG. 7 protruding from the back face 185 of the insulated block. The electrical plugs 188 may be pluggable into first and second receptacles 189 (FIG. 5) in the primary base plate 132. In one embodiment, the pluggable aspect of the insulated block 170 may be accomplished using banana plugs, which makes it very easy to unplug the insulated block 170 containing the heating element 172 and replace it with a new one, without requiring the disconnection of any of the wires 186 and reconnecting the same. In some embodiments, the insulated block 170 may be made of an insulating material, so that it does not act as a heat sink. For example, in some embodiments, the insulated block 170 may be made of a ceramic matrix.

Still referring to FIG. 5, the sealing mechanism 144 may include a support block 173 including a fixedly mounted, stationary base 174 having seated thereagainst or therein a plurality of springs 175 under compression that bias a generally linearly translatable upper bar 179 toward the interior surface of the second endless belt 126 most proximate the insulated block 170 (i.e., the upper run of the second endless belt 126). The support block 173 may be positioned facing the heating element 172 of the insulated block 170 with the linearly translatable upper bar 179 working cooperatively with the insulated block 170 to hold the film material against the heated surface of the first endless belt 124 to form the longitudinal seal while the film material is conveyed through the air pillow machine 102.

With reference to FIG. 3, the illustrative embodiment of the air pillow machine 102, as discussed above, may include a plug or plug receptacle 130 mounted to the primary base plate 132. The plug or plug receptacle 130 may be electrically connected to the motor 128, the fan 138, the heating element 172, and/or one or more sensors, such as the traction wheel sensor 190, by wires 186. In some embodiments, the motor 128 may be a 12V direct current motor. One of the sensors may include a traction wheel 190 rotatably mounted on a shaft 196 between supports 194, see FIGS. 4 and 5, with the traction wheel 190 in contact with the uninflated pillow-precursors for rotation of the traction wheel 190 in response to the conveyance of the uninflated pillow-precursors through the air pillow machine 102. The base plate 132 may define an elongate opening 197 positioned underneath the inflation nozzle 160 upstream of the feeding mechanism 140 and the sealing mechanism 144.

As seen in FIG. 5, the elongate opening 197 may be generally underneath at least a portion of the inflation nozzle 160 that defines the inflation opening 162. The traction wheel 190 may be positioned relative to a device (or arrangement of devices) to sense the speed 192 thereof. The device to sense the speed 192 may send a signal indicative of the sensed speed to a controller and the controller, based on the signal, may change the power of the motor 128, and hence the rate at which the uninflated pillow-precursors move through the machine. The power of the motor 128 can be increased or decreased as the situation demands. The device to sense the speed 192 may be an optical eye tracking one or more images, such as a line, dot, recess, or protrusion on the traction wheel 190 as it passes through each rotation. As is visible in FIG. 4, the traction wheel 190 may include a plurality of spaced apart holes or recesses 198 in at least one of the opposing axial faces 199 thereof and a sensor 192, such as a Hall effect sensor, sensing the passage of the plurality of spaced apart holes 198 or the surfaces in between the plurality of holes as the traction wheel passes through each rotation. In other embodiments, the device to sense the speed 192 may be determined by monitoring the movement of one or more of the first and second endless belts 124, 126, or the revolutions (rpm) of the shaft 153 of the primary gear 150 or the motor's rpm or the primary gear's rpms relative to the length of the first and second endless belts 124, 126.

The traction wheel 190 may be continuously biased partially through the hole 197 in the base plate by biasing members 195, typically springs, to keep the traction wheel in contact with the film material as it is fed through the machine. In one embodiment the springs are coil springs. In another embodiment, the springs are elastomeric springs.

With reference to FIG. 3, another sensor may include a resistance sensor electrically connected to the heating element 172. The resistance sensor may be part of the onboard electronics 135 or the off board electronics of the air pillow machine 102. By electrically connecting the heating element 172 to the controller 136 (in the onboard electronics 135 or off board electronics), the heating element 172 may be sensed or monitored using the electrical resistance R thereof. In one embodiment, the heating element 172 may include a nichrome wire. The resistance of the heating element 172 may be used by the controller to increase or decrease the voltage applied to the heating element 172 to maintain the heating element at a constant temperature for forming the longitudinal seal in the film material. The heating element 172 generally may not require a warm-up period, as it may heat to the sealing temperature nearly instantaneously. The resistance sensor may also functions to indicate on the display 216 of the machine 200 in FIG. 6 if the heating element 172 is broken. A broken heating element 172 will break the circuit, which may be detectable by the controller 136 and, hence may trigger the display of a message to the user to replace the heating element 172. The display may also include a listing of the instructions for the user to follow in replacing the heating element 172.

The film material of the pillow-precursor may be made of a variety of different materials, including films made of polyethylenic resins such as low density polyethylene (LDPE), linear low density polyethylene (LLDPE), and high density polyethylene (HDPE); metallocenes thereof; ethylene vinyl acetates (EVAs); and blends thereof, but is not limited to such. In one embodiment, the film material may be a polyethylene web, and the sealing wire may be kept at a temperature typically within the range of about 340° F. to about 600° F. (about 171° C. to about 316° C.), based on a sealing temperature appropriate for the type of film material being run through the air pillow machine 102 and the speed of motor (or the rate the film material is fed through the air pillow machine).

The uninflated air pillow precursors may include generally transverse seals and at least one perpendicular longitudinal seal or folded seam that define inflatable chambers. Typically, generally transverse perforations may be provided between adjacently neighboring inflatable chambers for ease of selecting a desired length of air pillows for the end use. Additional seals may be provided, as part of the uninflated air pillow precursor, within the inflatable chambers (between the transverse seals) if desired. These additional seals may be of any shape and configuration, including straight lines, curved lines, and angled lines.

Having described the invention in detail and by reference to preferred embodiments, it will be apparent that modifications and variations thereof are possible without departing from the scope of this invention.

What is claimed is:

1. An air pillow machine system comprising:
an air pillow machine including a primary base plate having mounted thereto a feeding mechanism, an inflating mechanism, and a sealing mechanism;
a frame having the primary base plate of the air pillow machine removably slidingly received therein; and
a housing, the frame being one of mounted at least partially within the housing and integral with the housing;
wherein a portion of each of the feeding mechanism, inflating mechanism, and sealing mechanism that engage an uninflated pillow-precursor protrude away from the primary base plate and away from the frame.

2. The air pillow machine system of claim 1, wherein the air pillow machine is secured within the frame by a releaseably attachable top plate.

3. The air pillow machine system of claim 1, wherein one or more of a motor and one or more sensors are electrically connected to one of a plug and a plug receptacle mounted to the primary base plate.

4. The air pillow machine system of claim 3, wherein one of the one or more sensors comprises a traction wheel rotated by the uninflated pillow-precursor fed through the air pillow machine and a device to sense the speed of the traction wheel.

5. The air pillow machine system of claim 4, wherein the device to sense the speed of the traction wheel sends a signal indicative of the speed of the traction wheel to a controller configured to change the power to the motor based upon, at least in part, the signal.

6. The air pillow machine system of claim 5, wherein the traction wheel includes a plurality of spaced apart holes in at least one axial faces of the traction wheel and the device to sense the speed of the traction wheel includes a sensor configured to sense one or more of the passage of the plurality of spaced apart holes and surfaces in between the plurality of holes as the traction wheel rotates.

7. The air pillow machine system of claim 6, wherein the sensor is a Hall effect sensor.

8. The air pillow machine system of claim 1, wherein the sealing mechanism comprises a heating element electrically connected to a controller, the controller configured to monitor a resistance of the heating element and to control a voltage applied to the heating element to maintain the heating element at a constant temperature.

9. The air pillow machine system of claim 1, wherein the inflating mechanism comprises a fan having a surge line.

10. The air pillow machine system of claim 9, wherein the fan is a vane style blower.

11. The air pillow machine system of claim 9, wherein the fan is positioned to cool electronics of the air pillow machine as ambient air is drawn into the fan.

12. The air pillow machine system of claim 1, wherein the sealing mechanism comprises:
an insulator block holding a heating element relative to a first belt of the feeding mechanism to seal the pillow-precursor subsequent to inflation; and
a first electrical plug connected to a first end of the heating element and a second electrical plug connected to a second end of the heating element, the first and second electrical plugs protruding from the insulator block and configured to be are plugged into receptacles coupled to the primary base plate.

13. The air pillow machine system of claim 1, wherein the frame has maximum dimensions of 12 inches by 10 inches by 6 inches.
